(19) United States
(12) Patent Application Publication
(10) Pub. No.: US 2003/0117700 A1
(43) Pub. Date: Jun. 26, 2003

(54) Microscope stand having auxiliary power outlet

(76) Inventors: Vincent Vaccarelli, Getzville, NY (US); David J. Cash, Kenmore, NY (US)

Correspondence Address: Simpson, Simpson & Snyder, PLLC, 5555 Main Street, Williamsville, NY, 14221, US

(21) Appl. No.: 10/027,088

(22) Filed: Dec. 20, 2001

(51) Int. Cl. G02B 21/00; G02B 21/06

(52) U.S. Cl. 359/368; 359/385

(57) ABSTRACT

A microscope stand is improved by the addition of an auxiliary power outlet for connection of a power cord associated with an auxiliary component, such as a video monitor. The improvement of the present invention diminishes reliance on extension cords in microscopy labs for a safer, more organized laboratory environment.

### FIELD OF THE INVENTION

The present invention relates generally to the field of microscopes, and more particularly to a microscope stand of the type that is connectable to a standard electrical outlet by way of a power cord.

### BACKGROUND OF THE INVENTION

Microscopes that provide one or more electrically powered elements, such as illumination sources for performing transmitted light microscopy and/or reflected light microscopy, are widely used throughout the world. These microscopes include a power inlet and a power cord specified for connection to a standard power outlet of the country or region where the microscope is used. For example, in North America, a power inlet and a power cord according to International Electrotechnical Commission (IEC) type 60320 are provided. Very often, the microscope is used in combination with one or more auxiliary components or accessory devices that also require electrical power. Video cameras, viewing monitors, illuminators, projectors, and the like are examples of auxiliary components commonly used with a microscope, especially in an educational microscopy laboratory setting wherein there are a plurality of microscope stations. Consequently, it is a problem to provide a sufficient number of electrical outlets for connection of the power cords of the auxiliary components in addition to the power cords of the microscopes themselves. Typically, extension cords must be run over the laboratory benches to provide the necessary number of power outlets. If this is not done in a neat and orderly fashion, a tangle of power cords will result. Despite the fact that this has been the situation at universities and other institutions for many decades, the problem remains. Therefore, there is a need to provide at least one additional power outlet located at each microscope station, preferably without rewiring the microscopy laboratory itself.

### SUMMARY OF THE INVENTION

To address the need stated above, a microscope stand of a type having an electrically powered element and a power inlet connected to the element is improved by providing an auxiliary power outlet for coupling a power cord of an auxiliary component such as a video monitor, computer, video camera, illumination source, or other device used in association with the microscope. The auxiliary power outlet can conform to the same standard as the microscope stand power inlet, or it can be a multi-standard interface for receiving a plurality of different regional power cord types. Optionally, a cover that is removable by a service technician but not by an end user is installed at the factory to block access to the auxiliary power outlet, whereby the auxiliary power outlet can be offered as a premium feature to purchasers.

### BRIEF DESCRIPTION OF THE DRAWINGS

The nature of the present invention will now be more fully described in the following detailed description of the preferred embodiments taken with the accompanying drawings and figures, in which:

FIG. 1 is a rear elevational view of a microscope formed in accordance with a preferred embodiment of the present invention;

FIG. 2 is view of region A of FIG. 1, showing a cover over an auxiliary power outlet of the present invention;

FIG. 3 is a schematic perspective view of an exemplary system including a microscope and an auxiliary component in accordance with the present invention; and

FIG. 4 is an electrical schematic diagram of the microscope of FIG. 1.

### DETAILED DESCRIPTION OF THE INVENTION

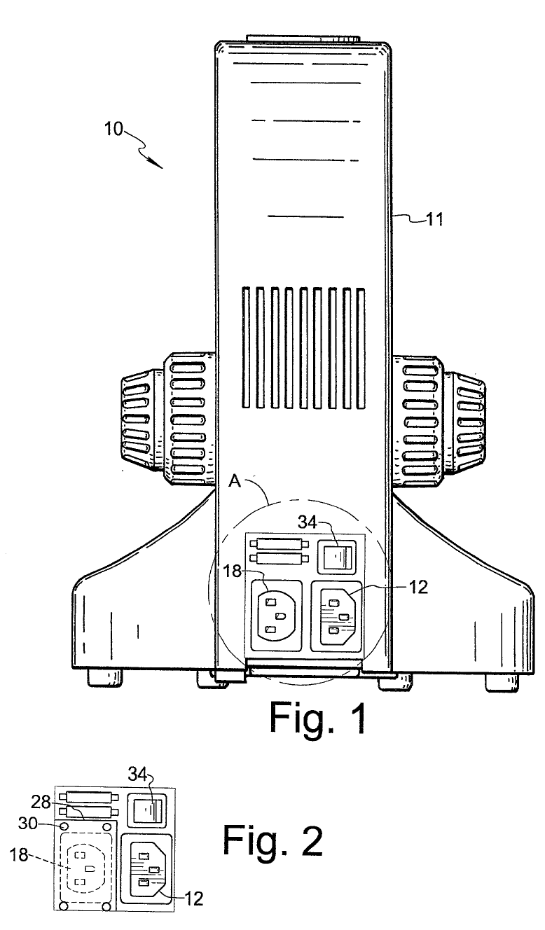

FIGS. 1 and 2 show a microscope 10 comprising a microscope stand 11 formed in accordance with a preferred embodiment of the present invention. At the bottom rear portion of microscope stand 11 is a male power inlet 12 for coupling with a female plug 14A of a power cord 14. A male plug 14B of power cord 14 is received by a standard female power outlet 16, such as a wall or bench outlet, wired to the building power supply. In accordance with the present invention, microscope stand 11 further comprises an auxiliary power outlet 18 adjacent power inlet 12 for connecting an auxiliary component 20, such as a video camera, monitor, computer, illumination source, or other useful component, to the building power supply. Auxiliary component 20 is connected, for example, by a power cord 15 having a female plug 15A coupled to a power inlet of the auxiliary component (power cord 15 might also be hard-wired at the power inlet of the auxiliary component) and a male plug 15B coupled to auxiliary power outlet 18 of microscope stand 11.

In the exemplary embodiment of FIGS. 1 and 2, power inlet 12, power cord 14, and auxiliary power outlet 18 conform to IEC 60320 used in North America. However, it will be understood that power inlet 12 may conform to any one of a plurality of standards used throughout the world, including but not limited to standards in use in Europe, United Kingdom/Ireland, Denmark, Italy, Switzerland, Australia, Israel, India/South Africa, China, Japan, and Argentina. For purposes of consistency in compatibility, auxiliary power outlet 18 should conform to the same standard as power inlet 12. Alternatively, auxiliary power outlet 18 could be made to conform to more than one standard, whereby a single configuration of the power outlet could receive more than one type of power cord plug. This alternative approach would avoid a level of customization in manufacturing.

It is also noted that auxiliary power outlet 18 can be a male prong connection for receiving a female plug, in the event that power cord 14 is compatible with this type of connection.

It is contemplated to offer auxiliary power outlet 18 as a product feature that is selectable by the customer. In this regard, auxiliary power outlet 18 can be built into all microscope stand units and blocked by a cover 28 as shown in FIG. 2. Cover 28 is attached to microscope stand 11 by a plurality of specialized fasteners 30 designed to be removable using a non-standard tool such that cover 28 is removable by a service technician but not by an end user. Of course, other arrangements for covering auxiliary power outlet 18 are possible that would enable a service technician, but not an end user, to remove the cover.

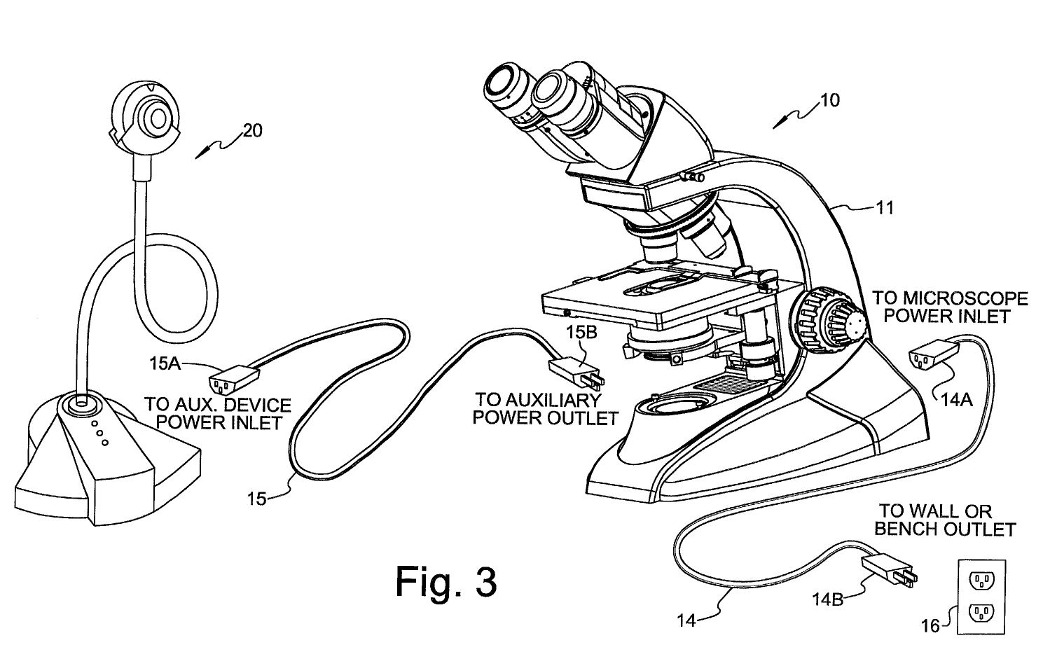

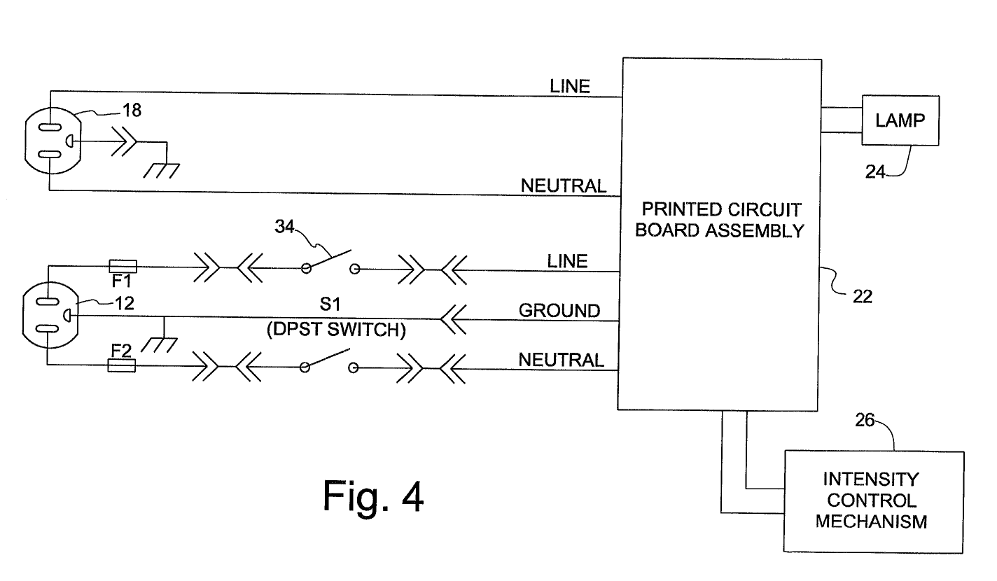

FIG. 3 is a schematic block diagram of the relevant electrical circuitry of microscope stand 11 according to the preferred embodiment. Microscope stand 11 comprises a main controller printed circuit board 22, a lamp 24 connected to circuit board 22, and an intensity control mechanism 26 also connected to circuit board 22 for controlling the voltage applied to lamp 24 to regulate the intensity of illumination provided by the lamp. Microscope stand 11 further comprises power inlet 12 with dual-pole fuse holders used to accept any IEC-60320-1 style power cord for connecting the power cord to the circuit board 22. A double-pole, single throw switch 34, normally open, is preferably provided between power inlet 12 and circuit board 22. The input power signal is transmitted via circuit board 22 to auxiliary power outlet 18, and to a universal power supply (not shown) associated with circuit board 22 for converting the power signal to a direct current voltage powering the circuit board elements.

It will be appreciated by those familiar with microscopy laboratories that the present invention solves a longstanding problem by decreasing or eliminating the need for extension cords running on or around the lab benches. This results in a safer laboratory setting because tripping over cords is less likely. In addition, the invention allows better workspace organization and gives the microscopy laboratory a less cluttered appearance.

What is claimed is:

1. In a microscope stand of a type having an electrically powered element and a power inlet connected to said element, the improvement comprising:
an auxiliary power outlet connected to said power inlet for receiving a power cord of an electrically powered auxiliary device associated with said microscope stand.

2. The improvement according to claim 1, wherein said power inlet of said microscope stand and said auxiliary power outlet are formed according to a common standard chosen from a plurality standards in use throughout the world.

3. The improvement according to claim 1, further comprising a cover installed to prevent access to said auxiliary power outlet, wherein said cover is adapted to be removable by a service technician but not by an end user.

4. The improvement according to claim 1, wherein said electrically powered element is an illumination source.
